(19) United States
(12) Patent Application Publication
(10) Pub. No.: US 2006/0214923 A1
(43) Pub. Date: Sep. 28, 2006

(54) Touchpad having capability of inducing sensation of tactile key

(76) Inventors: Yen-Chang Chiu, Taipei County (TW); Wen-Kai Lee, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/293,312

(22) Filed: Dec. 5, 2005

(30) Foreign Application Priority Data
Mar. 28, 2005 (TW) 094109630

(51) Int. Cl. G09G 5/00

(52) U.S. Cl. 345/173

(57) ABSTRACT

A touchpad having capability of inducing sensation of tactile key comprises a deformable cover provided over a sensor, the deformable cover having a key region. The deformable cover is presented as a flat shape or curved shape. The key region is provided with a projecting structure, recessed structure, or flat structure. Preferably, the key region is provided thereon with a pattern representative of a key. Alternatively, the touchpad further comprises a support member provided between the deformable cover and the sensor. Preferably, the support member is provided underneath the key region with a recess.

### FIELD OF THE INVENTION

The present invention is generally related to a touchpad and, more particularly, to a touchpad having capability of inducing sensation of tactile key.

### BACKGROUND OF THE INVENTION

Owing to small volume, low cost, low power consumption, and long lifetime, touchpads have been widely used in various electronic products, such as notebooks, mice, MP3 players, and even cellular phones, etc., to serve as input devices. Three types of touchpad including resistive, electromagnetic, and capacitive touchpads are known in the art. In operation, a pen tip is required to exert the force onto an extremely small area for a resistive touchpad, and a special pen equipped with battery is needed to perform input operations cooperatively for an electromagnetic touchpad. Thus, the capacitive touchpad is superior to the resistive and electromagnetic ones in view of function and cost. The working principle of a capacitive touchpad is understood to apply a capacitive effect generated at the moment when an object touches the touchpad, in such a way that the position where the object touches may be determined by the variance in capacitance. Thereby, unlike the electromagnetic touchpad necessarily being operated with the help of the input pen with power consumption, and also unlike the resistive touchpad requiring a concentrated pressurized point, a longer life-time may be thus obtained for a capacitive touchpad. Further, owing to simple construction, fewer elements, high yield of manufacture, the cost for the mass production of capacitive touchpad may be lower.

The capacitive touchpad may be operated in several ways, the most common one of which is the contact or sliding of a finger or pen on a surface of the touchpad, in such a way that a corresponding signal may be generated by a sensor of this touchpad. The sensor is a device including one-dimensional or two-dimensional traces, normally formed by a conductor etched on a printed circuit board having either single-layer, double-layer, or four-layer structure with essentially the same object-sense principal. For the protection and attractiveness of sensor, the sensor is covered thereon with a layer of smooth insulator commonly made of insulator adhesive material and plastic shell mainly. Referring to a flat touchpad illustrated in FIG. 1 and a curved touchpad illustrated in FIG. 2, for example, a cover 12 over a sensor 10 has an insulative function, and is provided with a smooth surface where the finger of a user may be allowed to contact and slide. Further detailed structure may be found by referring to U.S. Pat. No. 5,374,787 to Miller et al.

There are quite a few functions being provided by a touchpad. In U.S. Pat. No. 5,748,185 to Stephan et al., for example, a cursor control region, a scroll control region, and a pan control region are defined to be linked to commands or functions within a graphical user interface (GUI). Furthermore, in U.S. Pat. No. 5,943,052. to Allen et al., the sliding of a finger in a defined scroll region may be used for the scroll control of a window directly via a processor software. A touchpad may be also used to simulate keys in place of former mechanical keys, as illustrated in Taiwanese Utility Model No. 240,050, for example. When the touchpad is applied to simulate keys, however, it is impossible for the user to receive feedback through his finger and then to perceive the press and release of the key when the virtual key of the touchpad is operated by this user, due to the fact that the touch sensation, similar to that occurring in the operation of the mechanical key, is impossibly provided by the insulator which covers on the sensor. In this case, moreover, there is no choice but waiting for the response from the control system; if no response is received, the action of re-pressing is required. Several merits, such as lifetime being longer than that of the key and improbability to damage the touchpad, as examples, may arise from the simulation of keys by means of the touchpad. For the user, however, the foregoing feature of difficulty in recognition may occur in the virtual keys of the touchpad. The generation of key signal for the mechanical key may take place when this key is compressed by means of the application of force, while the generation of signal in the operation of the touchpad may take place without any change in appearance. Thus, the aforementioned difficulty is hard to be overcome.

Therefore, it is desired a touchpad to have the capability of inducing sensation of tactile key while providing an extremely easy recognition and use of the function of virtual keys to a user.

### SUMMARY OF THE INVENTION

One object of the present invention is to provide a touchpad having capability of inducing sensation of tactile key.

In accordance with the present invention, a touchpad having capability of inducing sensation of tactile key comprises a deformable cover provided over a sensor, the deformable cover having a key region.

In one embodiment, the key region is provided with a projecting structure.

In another embodiment, the key region is provided with a recessed structure.

In still another embodiment, the key region is provided with a flat structure.

In one embodiment, the key region is provided thereon with a pattern representative of a key.

In one embodiment, the touchpad further comprises a support member provided between the deformable cover and the sensor.

In one embodiment, the support member is provided underneath the key region with a recess.

In one embodiment, the deformable cover is presented as a flat shape.

In another embodiment, the deformable cover is presented as a curved shape.

The deformable cover may be fixed to the sensor or support member by means of gluing, screwing, insertion, or in other ways.

The sensation of the press and release of the key may be obtained for the user in operation, due to the deformable cover which generates deformation when the key region is pressed, while restores when it is released.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a conventional flat touchpad;

FIG. 2 shows a conventional curved touchpad;

FIG. 3 is a perspective diagram showing a touchpad according to a first embodiment of the present invention;

FIG. 4 is a perspective diagram showing a touchpad according to a second embodiment of the present invention;

FIG. 5 is a perspective diagram showing a touchpad according to a third embodiment of the present invention;

FIG. 6 shows a cross-sectional view of the touchpad illustrated in FIG. 3;

FIG. 7 shows a cross-sectional view of the touchpad illustrated in FIG. 4;

FIG. 8 shows a cross-sectional view of the touchpad illustrated in FIG. 5;

FIG. 9 is a diagram showing the pressing of a key on the touchpad illustrated in FIG. 3;

FIG. 10 is a diagram showing the pressing of a key on the touchpad illustrated in FIG. 4;

FIG. 11 is a diagram showing the pressing of a key on the touchpad illustrated in FIG. 5;

FIG. 12 is a cross-sectional view showing a touchpad according to a fourth embodiment of the present invention;

FIG. 13 is a cross-sectional view showing a touchpad according to a fifth embodiment of the present invention;

FIG. 14 is a cross-sectional view showing a touchpad according to a sixth embodiment of the present invention;

FIG. 15 is a diagram showing the pressing of a key on the touchpad illustrated in FIG. 12;

FIG. 16 is a diagram showing the pressing of a key on the touchpad illustrated in FIG. 13;

FIG. 17 is a diagram showing the pressing of a key on the touchpad illustrated in FIG. 14;

FIG. 18 shows a top view of a touchpad according to the present invention;

FIG. 19 shows a curved touchpad according to one embodiment of the present invention;

FIG. 20 is a diagram showing the relationship between the amount of deformation of a cover and the variance in capacitance generated by a sensor;

FIG. 21 is a diagram showing the gluing of the covering to a sensor;

FIG. 22 is a diagram showing the screwing of the covering onto a sensor; and

FIG. 23 is a diagram showing the insertion of the covering into a sensor.

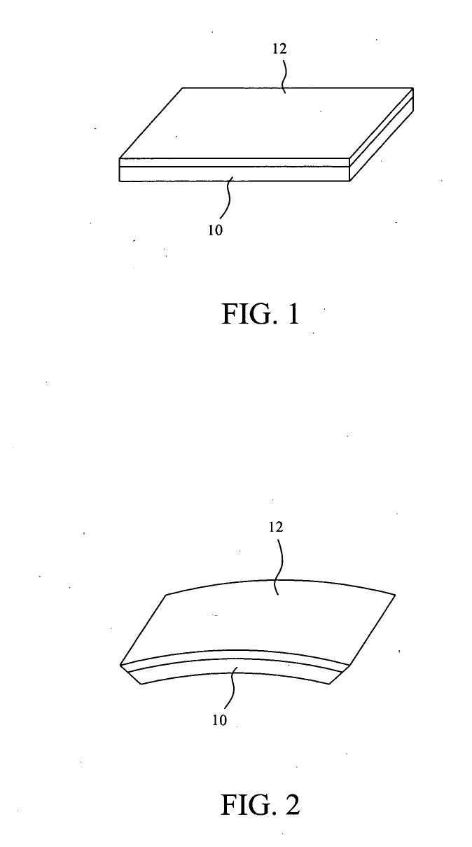

### DETAILED DESCRIPTION OF THE INVENTION

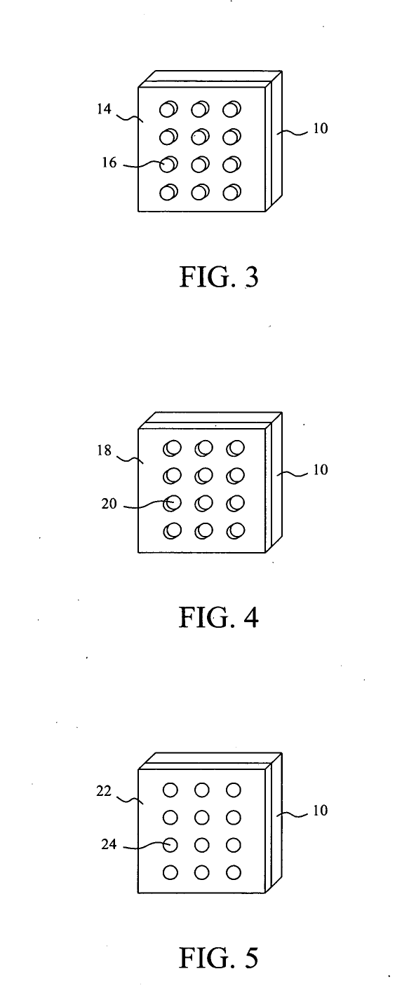

FIGS. 3 to 5 are perspective diagrams showing three embodiments of touchpads. In the touchpad illustrated in FIG. 3, a sensor 10 is provided thereon with a cover 14 having twelve key regions 16 thereon, each key region 16 having a projecting structure thereon with a thickness D. In the touchpad illustrated in FIG. 4, a cover 18 provided over a sensor 10 is provided with twelve key regions 20, each having a recessed structure thereon, and is provided with a thickness D at the center of this recessed structure. In the touchpad illustrated in FIG. 5, over a sensor 10, there is provided with a cover 22 with a thickness D, having twelve key regions 24 presented as a flat structure thereon. The key region herein is referred to as a region on the cover, used as a key for a user to operate, corresponding to a region of the sensor desirably achieving the function of virtual key. When the pressing of the key region provided by an object is detected by the sensor, a key signal is generated accordingly.

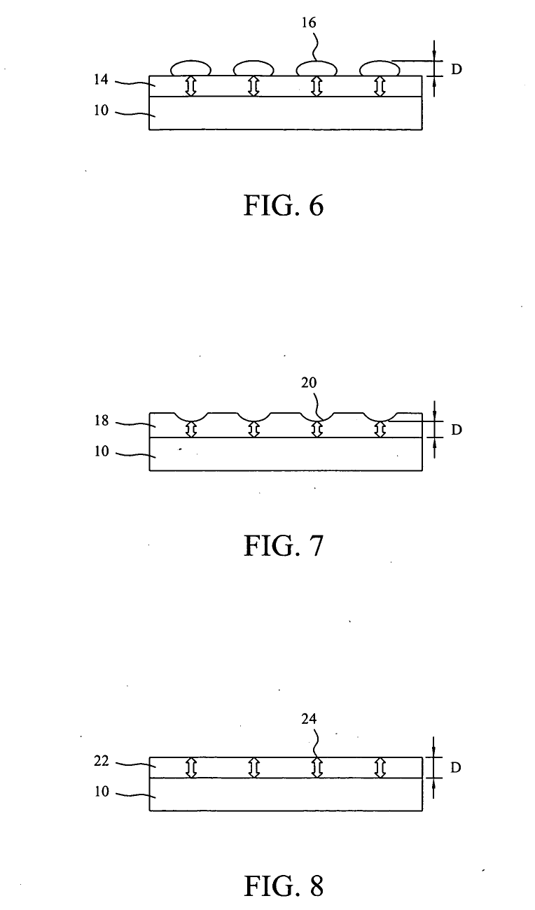

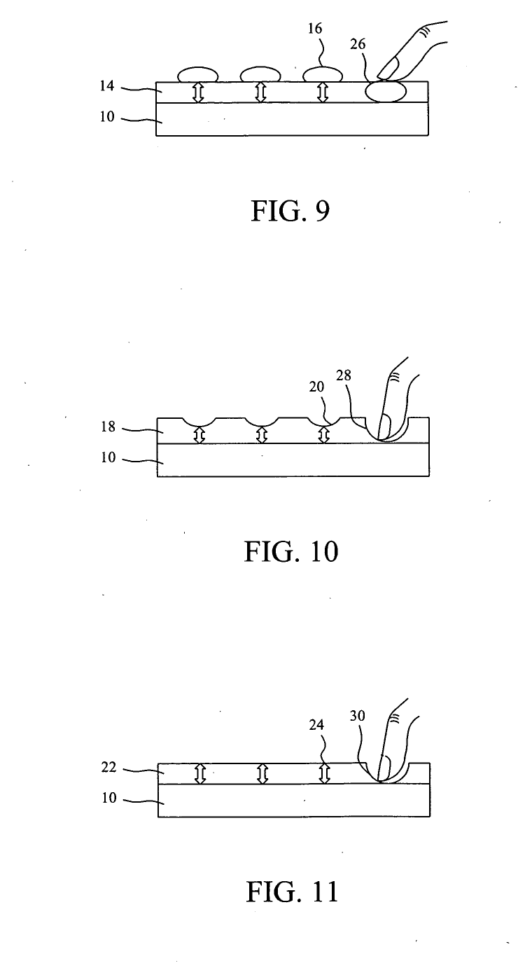

FIGS. 6 to 8 are cross-sectional views of the touchpads illustrated in FIGS. 3 to 5. The covers 14, 18, and 22 are all deformable insulators, which may deform under the compression of external force. Referring to FIGS. 9 to 11, provided that the key region is pressed by a finger, the cover 14, 18, 22 may deform in the pressed key region 26, 28, 30, correspondingly, in such a way that the finger may approach the sensor 10, and the key signal may be then generated. The cover 14, 18, 22 may restore when the finger is released, as illustrated in FIGS. 6 to 8. The sensation of pressing and releasing the key may be provided for a user, owing to the feedback sensation generated from the deformation of the cover 14, 18, 22 to the user. In the meanwhile, the action of pressing and releasing the key provided by the user may be received by the sensor 10, equally due to this deformation.

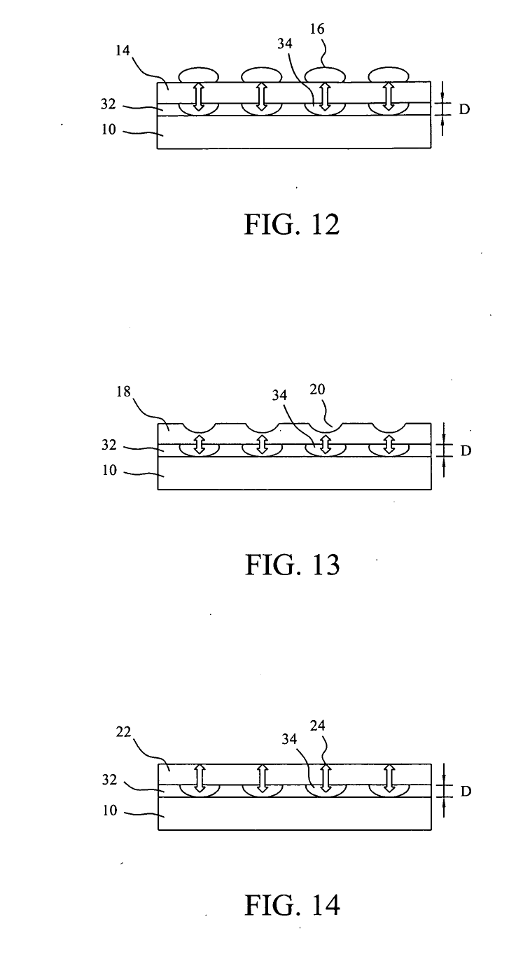

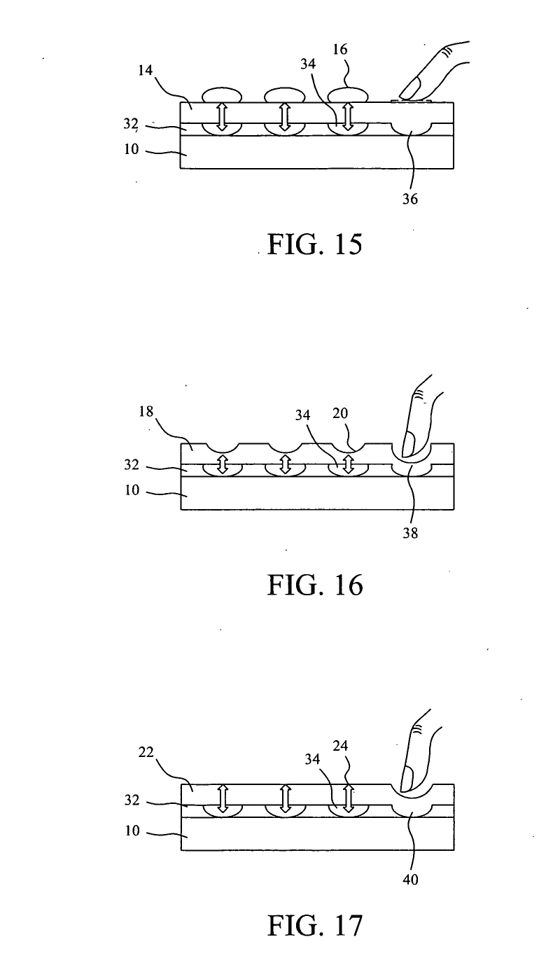

FIGS. 12 to 14 are cross-sectional views of touchpads according to other embodiments of the present invention. Between the sensor 10 and cover 14, there is provided with a support member 32 with recesses 34, each having a thickness D, underneath the key regions 16, as shown in FIG. 12. Between the sensor 10 and cover 18, there is provided with a support member 32 with recesses 34, each having a thickness D, underneath the key regions 20, as shown in FIG. 13. Similarly, between the sensor 10 and covering 22, there is provided with a support member 32 with recesses 34, each having a thickness D, underneath the key regions 24, as shown in FIG. 14. As a finger presses the key region, as shown in FIGS. 15 to 17, the cover 14, 18, and 22 may deform in the pressed key region 36, 38, and 40 so as to stuff into the recess 34, in such a way that the finger may be allowed to approach the sensor, and the key signal may be generated accordingly. As the finger releases, the covers 14, 18, and 22 may restore, as shown in FIGS. 12 to 14. In these three embodiments, the support member is an insulator, while the covers 14, 18, and 22 may be an insulator or a conductor. In some embodiments, the support member is thin without recess underneath the key region, simply providing the effect in protecting the sensor.

In the operation of these touchpads, whether the key input has been completed is known to the user by means of the feedback sensation provided by the change in shape of the covering directly, without the need for the response from a control system to perceive whether the action of pressing and releasing the key has been completed. Unlike a smooth surface of the former touchpad, it is considerably definite and easy for the user to find out and operate the key by the use of the structure made on the key region of the cover, particularly at night.

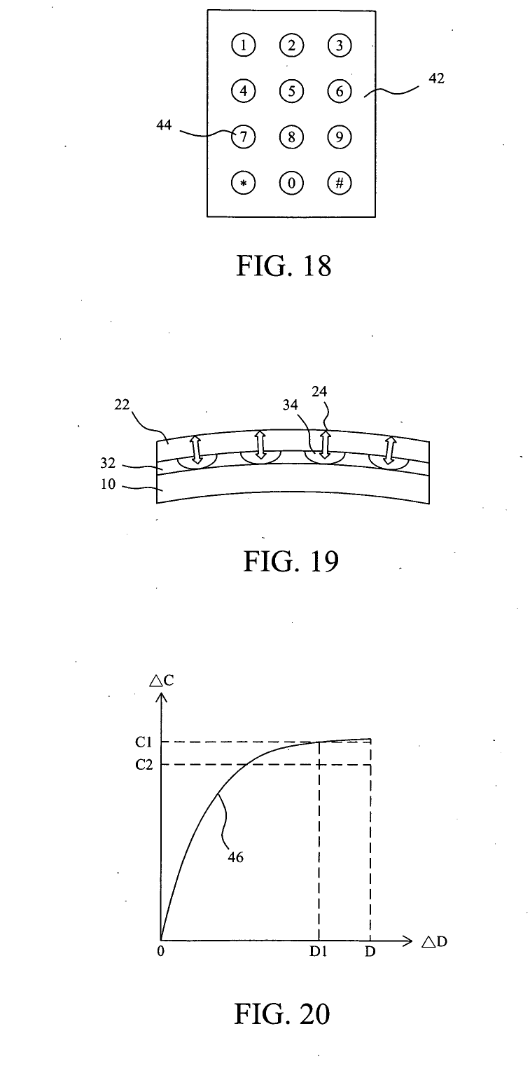

FIG. 18 shows a top view of a touchpad according to the present invention. Each key region 44 of the cover 42 is provided thereon with a pattern representative of a key. This pattern may be not only in the form of a flat printed on the surface of the key region 44 or adhered on the key region 44, as examples, but also a solid body, such as a pattern or rugged surface shaped on the key region 44.

Except for the flat shape in each of aforementioned embodiments, the touchpad may be also formed into a curved shape. As shown in FIG. 19, the sensor 10 and cover 22 may be presented as a curved surface each, respectively, while the key region may be also formed thereon with the projecting structure or recessed structure in the above embodiments.

FIG. 20 is a diagram showing the relationship between the amount of deformation ΔD of a cover and the variance in capacitance ΔC generated by a sensor. When a key region is not pressed yet, the variance in capacitance is zero, since there is no deformation generated in the cover. The deeper the key region is depressed, the greater the amount of deformation ΔD of the cover is; i.e., the variance in capacitance ΔC is larger as the finger approaches the sensor further, as indicated by a curve 46. C1 represents a critical value regarding when the key signal is permissibly generated, and the pressing depth corresponding thereto is indicated by D1. In other words, the key signal may be generated by the sensor when the pressing depth ΔD of the key region exceeds the critical value D1. The sensitivity of the key may be adjusted by means of the adjustment of the critical value. For instance, the key signal is triggered more easily by the touchpad having a critical value set as C2 than by that having the critical value set as C1. Also, the sensitivity of the key may be affected by the flexibility of the cover. For instance, the amount of deformation of a more flexible cover may exceed the critical value D1 so as to generate the key signal under a less pressure. The operation of the sensor is well known in this art, possibly achieved by hardware, software, or firmware.

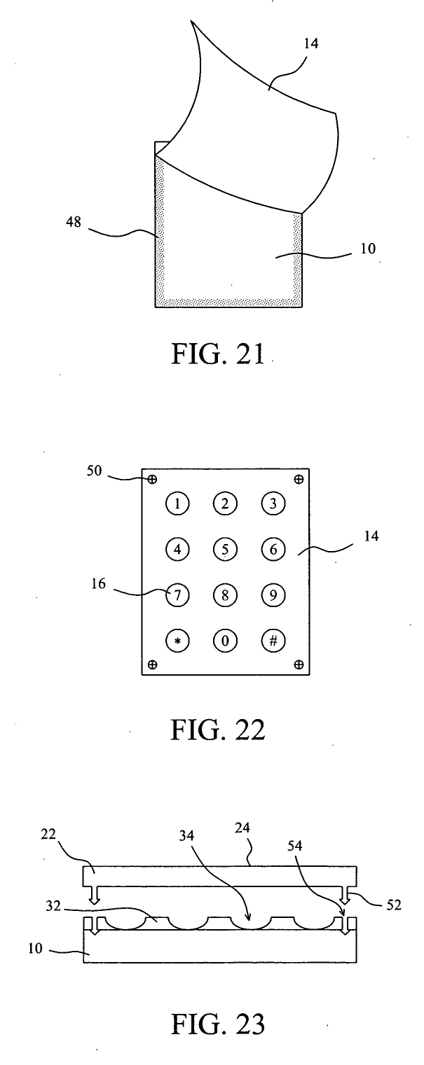

The cover may be fixed to the sensor or support member by means of gluing, screwing, insertion, or in other ways. Taking the example of the touchpad illustrated in FIG. 3, as shown in FIG. 21, an adhesive 48 is applied around the periphery of the surface of the sensor 10, so as to glue the cover 14 to the sensor 10. Taking the example of the touchpad illustrated in FIG. 12, as shown in FIG. 22, screws 50 are used to screw the cover 14 onto the support member 32 at four corners of the touchpad. Taking the example of the touchpad illustrated in FIG. 14, as shown in FIG. 23, there are provided with posts 52 at the bottom of the cover 14, and insertion holes 54 provided on the support member 32 and sensor 10. By forcing the posts 52 into the insertion holes 54, the cover 14 may be then fixed to the support member 32. The cover is replaceable in some embodiments. For instance, a cover with different key patterns or structure may be used instead, in order to simulate different keys or change the positions of key regions. The sensitivity of the key may be changed when a more flexible or stiffer cover is used substitutively. The additional advantages, such as replacement of the dirtied or scraped one, may be obtained in case the replaceable cover is used.

In the present invention, although sensation of tactile key is induced by the deformation of the cover, the disadvantage of the mechanical key, such as demands for precise electrical contact points and for debounce mechanism, and mechanical wear, as examples, may not emerge accordingly. Therefore, the advantages of touchpad and the mechanical key may be obtained simultaneously without any disadvantage of the latter in the present invention.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A touchpad having capability of inducing sensation of tactile key, comprising:
a sensor; and
a deformable cover provided over the sensor, the deformable cover having a key region.

2. The touchpad of claim 1, wherein the key region is provided with a projecting structure.

3. The touchpad of claim 1, wherein the key region is provided with a recessed structure.

4. The touchpad of claim 1, wherein the key region is provided with a flat structure.

5. The touchpad of claim 1, wherein the key region is provided thereon with a pattern representative of a key.

6. The touchpad of claim 1, wherein the deformable cover is an insulator.

7. The touchpad of claim 1, wherein the deformable cover is presented as a flat shape.

8. The touchpad of claim 1, wherein the deformable cover is presented as a curved shape.

9. The touchpad of claim 1, wherein the deformable cover is glued to the sensor.

10. The touchpad of claim 1, wherein the deformable cover is screwed onto the sensor.

11. The touchpad of claim 1, wherein the deformable cover is inserted into the sensor.

12. The touchpad of claim 1, further comprising a support member provided between the deformable cover and the sensor.

13. The touchpad of claim 12, wherein the key region is provided with a projecting structure.

14. The touchpad of claim 12, wherein the key region is provided with a recessed structure.

15. The touchpad of claim 12, wherein the key region is provided with a flat structure.

16. The touchpad of claim 12, wherein the key region is provided thereon with a pattern representative of a key.

17. The touchpad of claim 12, wherein the support member is an insulator.

18. The touchpad of claim 12, wherein the deformable cover is an insulator.

19. The touchpad of claim 12, wherein the deformable cover is a conductor.

20. The touchpad of claim 12, wherein the deformable cover is presented as a flat shape.

21. The touchpad of claim 12, wherein the deformable cover is presented as a curved shape.

22. The touchpad of claim 12, wherein the deformable cover is glued to the support member.

23. The touchpad of claim 12, wherein the deformable cover is screwed onto the support member.

24. The touchpad of claim 12, wherein the deformable cover is inserted into the support member.

25. The touchpad of claim 12, wherein the support member is provided with a recess under the key region.

26. The touchpad of claim 25, wherein the key region is provided with a projecting structure.

27. The touchpad of claim 25, wherein the key region is provided with a recessed structure.

28. The touchpad of claim 25, wherein the key region is provided with a flat structure.

29. The touchpad of claim 25, wherein the key region is provided thereon with a pattern representative of a key.

30. The touchpad of claim 25, wherein the support member is an insulator.

31. The touchpad of claim 25, wherein the deformable cover is an insulator.

32. The touchpad of claim 25, wherein the deformable cover is a conductor.

33. The touchpad of claim 25, wherein the deformable cover is presented as a flat shape.

34. The touchpad of claim 25, wherein the deformable cover is presented as a curved shape.

35. The touchpad of claim 25, wherein the deformable cover is glued to the support member.

36. The touchpad of claim 25, wherein the deformable cover is screwed onto the support member.

37. The touchpad of claim 25, wherein the deformable cover is inserted into the support member.
